(19) United States
(12) Patent Application Publication
(10) Pub. No.: US 2004/0227973 A1
(43) Pub. Date: Nov. 18, 2004

(54) System and method for distributing printer properties on a computer network

(76) Inventor: Jarrett D. Taylor, St. George, UT (US)

Correspondence Address: Steve M. Perry, THORPE NORTH & WESTERN, L.L.P., P.O. Box 1219, Sandy, UT, 84091-1219, US

(21) Appl. No.: 10/407,971

(22) Filed: Apr. 4, 2003

Related U.S. Application Data
(60) Provisional application No. 60/370,450, filed on Apr. 4, 2002.

(51) Int. Cl. G06F 3/12; G06F 15/00; G06F 13/00

(52) U.S. Cl. 358/1.15; 709/223

(57) ABSTRACT

A system and method is provided for distributing printer properties to at least one client computer on a computer network. The method includes the step of configuring a printer property profile using an administrator tool. Another step is storing the printer property profile on an electronic storage medium. A further step is applying the stored printer property profile to a printer on the client computer so that the client computer possesses current printer properties as defined by the printer properties profile.

This application claims priority to provisional patent application 60/370,450 filed on Apr. 4, 2002 entitled “SYSTEM AND METHOD FOR DISTRIBUTED PROPERTIES ON A COMPUTER NETWORK”.

### FIELD OF THE INVENTION

This invention is related to distributing printer properties on a computer network.

### BACKGROUND

In a computer network, it is valuable to be able to remotely administer client computers that can access the network and network servers. This is because the individual administration of each client computer that is accessing the network can be costly in terms of time, money and other resources. If a network administrator is not able to remotely administer the network clients then the administrator must physically visit each client computer to install software and fix problems. Remotely administered networked systems typically include client computers which each have a piece of software that communicates with an administration program loaded on a network server to control the software loaded on the clients.

Networked systems that are running remote network configuration software enable the network configuration software to remotely install software and manage client (or workstation) profiles. One specific function provided by these remote network administration tools is that the remote client software can install a predefined list of computer programs for a user. In other words, the group of programs needed by a user can be considered a configuration for that client computer. Additionally, the remote administration tool provides a central listing of information about the users, applications, and the equipment that makes up the network. This type of remote management system allows a network administrator to associate applications and desktop settings with individuals based on who they are or their role in a company. Network administrators can also associate applications with individual desktops, departments or the overall organization. As a result, a remote administration tool can aid in network auditing and planning. At least two of the products that exist in this area are ZENworks by Novell and LANdesk by Intel.

Companies have spent hundreds of millions of dollars on such automated network management software. One force driving this spending is the desire of organizations to reduce the total cost of ownership of network-attached devices and to increase the productivity of network administrators and end users. A shift to centralized network management also signals a shift from a computer-centric network support model to a user-centric model for network administration.

Directory-based desktop network management software increases network administrator productivity by automating the distribution and management of applications and other desktop software. Another advantage of this type of remote management is that it enables central maintenance of the user's application requirements and the management of a large number of desktops.

Users benefit from the remote maintenance model because they are able to avoid interruptions in their work that are caused by software and hardware malfunctions or upgrades. A reduction in malfunctions and upgrades results in increased productivity. For example, the longer a malfunctioning desktop keeps a user waiting for it to be fixed, the larger the loss for a company. Centralized desktop management also minimizes the time lost waiting for help desk support. Users can also be more productive when disruptions caused by network administrative activities are reduced, such as upgrading applications, integrating new desktops and users into the network, and polling for hardware and software inventory.

Since these distributed network management tools are intended to support network administrators, the tools must perform a number of tasks to support users, desktops, and server environments. Any interruption of users' work translates into lost revenue, and network administrators must perform their duties in an efficient and productive manner while taking every step to minimize downtime. Typically, the network administrators' duties include several things. One is supporting application, installations and upgrades. Another is deploying new client computer hardware and configuring that hardware. A further responsibility is keeping users' applications at the same version level to prevent inconsistencies among desktops within a company. Network administrators may also keep track of inventory, control access, and secure the network against external and internal threats. Since network administrators have such rigorous demands on their time, the use of a more effective and complete automated administration solution would be valuable to network administrators.

### SUMMARY

The invention includes a system and method for distributing printer properties to at least one client computer on a computer network. The method includes the step of configuring a printer property profile using an administrator tool. Another step is storing the printer property profile on an electronic storage medium. A further step is applying the stored printer property profile to a printer on the client computer so that the client computer possesses current printer properties as defined by the printer properties profile.

### BRIEF DESCRIPTION OF THE DRAWINGS

FIG. 1 is a block diagram of a system for configuring properties for a client computer on a network in accordance with an embodiment of the present invention;

FIG. 2 is a flow chart of a method for configuring printer properties for a client computer in a networked operating environment in an embodiment of the invention;

FIG. 3 is a flow chart showing a more detailed embodiment of a method of configuring printer properties using a central repository and importing the printer properties into the client computer.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the invention as illustrated herein, which would occur to one skilled in the relevant art and having possession of this disclosure, are to be considered within the scope of the invention.

Despite the fact that previous network administration tools have been able to install programs and other peripheral software (such as printers and associated drivers), these network administration tools have not been able to setup the configurations and properties of the printers that are being loaded. Network administrators are able to remotely install printers, but then the administrators physically go and access each client computer system to modify the printers' configurations, options and settings. For example, the network administrator needs to visit the client computer and set up the duplex printing option, extra paper bins, paper trays, paper source, paper size in each tray, and the myriad of other options and properties the printer provides. This is a problem for network administrators because of the amount of time required to individually configure the properties for the printers on each separate client computer. This simply consumes more of the network administrator's time and is a step that they would rather avoid. The network administration software does not take care of the configuration of a printer's properties and settings because there is no standard in the printer industry for printer properties. Each printer manufacturer develops their own printer driver and driver options for each printer type and model. In addition, printer manufacturers do not use the same methods to configure printer properties. One printer might have the option to print the first page of a document from a specified tray and the rest of the document from another tray, while other printers do not have this option but have their own individual and unique options. Therefore, the network administration software would have to invest considerable time and effort in trying to figure out a way to be able to configure each printer property of every printer of every printer manufacturer. In addition the developers of the network administration software would be required to continuously update the software each time a new printer is manufactured that uses a different configuration method.

The present invention provides an improved system and method for administrating printer properties data that is currently lacking in network management software as illustrated by the following description of a printer install scenario. Each user who logs into a computer network may have their printer(s) installed by the network management software. One program that exists to simply install the printer drivers is Novell Distributed Print Services. When a user logs into the network, the distributed print service has a number of pre-defined printers that are associated with the user. Regardless of which client machine a user is logged into, the distributed print services can check to see if the user's printer exists on that machine or if the needed printer should be installed as a result of the login.

Once these printers have been installed, there are certain configurations that can be applied to the physical printer hardware. Some additional functionality that the printer may be able to perform is the selection of the paper source tray, paper size, extra trays, duplex options, and a plethora of other specific options the manufacturer provides. In some countries, such as European countries, the users would like to have the default paper size set to A4 and have that setting match the correct paper tray. Since the printer drivers are often produced in the United States, the default setting for the printer drivers are set to U.S. printer settings (e.g., 8 ½×11 paper). Because the network management software and administration tools cannot set the printer properties, the network administrator must go to each client machine and separately set those settings on each user's machine. In some situations, the printer properties and settings may only be changed when the user asks for the properties to be changed and that ad hoc request may be inconvenient for the network administrator. Network administrators also frequently find that end users either are not familiar with what these properties and settings mean and/or they do not know where these settings are located within the operating system, even if they wanted to access them.

One of the reasons that remote management software and administration tools have not been able to change these types of settings is that it is difficult to change a printer's properties and other configuration settings. The mindset has been that a printer's properties are generally accessed through the printer's individual interface and the network administration tool cannot take care of it.

Another reason remote administration tools cannot take care of printer specific properties and settings is the nature of printers and associated software being installed. The printer manufacturers do not provide an interface to pre-configure the properties and options of the printers they make. The manufacturers only provide an install script to install the printer and associated files. When a printer is installed by the remote administration tools, the remote administration program cannot be instructed to configure the printer properties because the printer manufacturer does not provide the option in the install script. Therefore remote administration programs are not able to change the configuration of the printer.

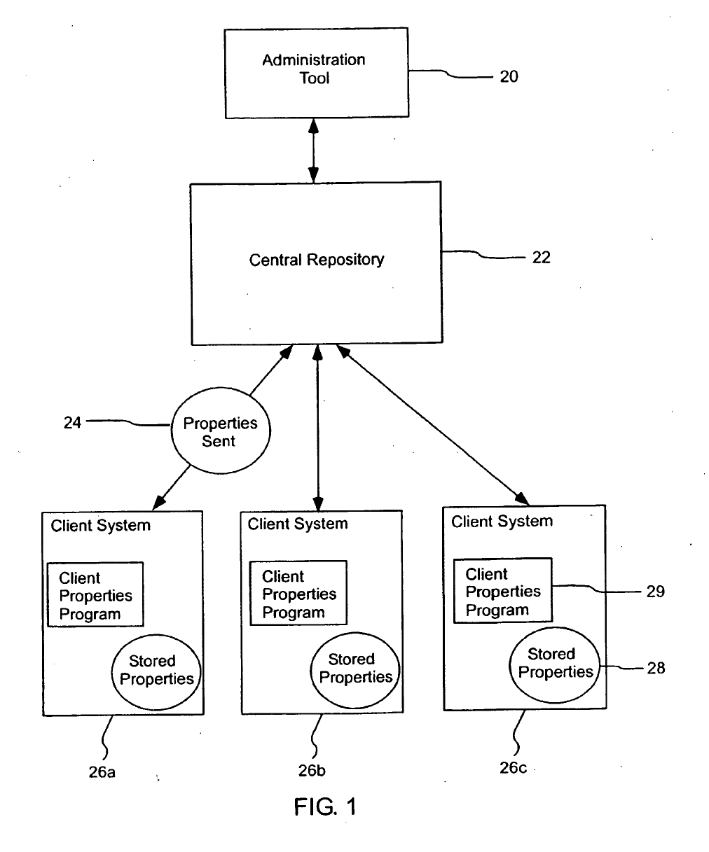

As illustrated in FIG. 1, the present invention includes a system and method for configuring printer properties for a client computer on a computer network. By using the administrator tool, the printer properties from a printer properties profile are copied to a central repository for storage. Then these properties can be transferred from the central repository to one or more client computers to configure the printer properties on the client computers. One specific embodiment copies printer properties to the central repository and then uses those stored printer properties to configure the printer properties on the client computers. Printer property data is generally defined as printer properties, printer settings, printer options, printer preferences, printing defaults, device settings, color management, and all other user defined settings associated with printer properties.

FIG. 1 illustrates an embodiment of this invention that is used for administrating printer properties. An administration tool 20 is initiated or run by a network administrator. The administration tool itself can be stored locally on a workstation or on a server. If the administrator tool is stored on the server then the network administrator can access it from any network attached computer or server. The administration tool allows the network administrator to select a printer, then open the properties of the selected printer, and change the properties and settings of the printer. If the printer has been configured previously by the administration tool, the previous properties are read prior to showing a graphical user interface of the printer properties. Specifically, when the properties graphical interface is opened, the administrator views the properties exactly as the users would normally be able to view them (through the properties window on an operating system). The saved settings are stored in a central repository 22, file, or database.

The central repository 22 is located on a server and is accessible by the administration tool 20. This central repository can hold a separate file for each of the printer property profiles or it can be a flat file that stores each of the printer property profiles in separate groups. Alternatively, the printer property profiles might be stored in a relational database where properties, property names, and values are stored in different tables. Of course, other schemes can be used to compress the data or store the data in other formats.

Once the properties have been defined they may be associated with users, groups, organizational entities or other groupings. This allows the network administrator to create a group of users in the organization with which these properties will be associated. This means that even if printers are switched between physical locations, the printer groups can also be easily switched.

At a later point in time, the client systems 26a, 26b, 26c can run the client properties program 29 on the client computers. The client properties program will run either at the specific request of a user or it may be set to run at specific times or system events. For example, the printer properties program may run when the user logs into the network. Alternatively, the properties program may be a program that loads and stays resident in the operating system in order to run periodically or at specific operating system events. The client properties program can be set to run every hour or every day to keep the properties in sync with what is stored in the server's central repository.

When the client properties program 29 executes, either from a local drive, remote server or other media, it tests the client system's operating system to see which printers they currently have installed, then the program can check to see whether the printer properties for each printer should be updated. If the client system does need to update the printer properties, then the printer property profile 24 is sent or loaded from the central repository 22 and installed onto the client system 26a to configure the printer properties on the client computer. The configured printer properties can be stored in a selected location on the client system 28. A printer property profile is generally considered all of the printer property data for a selected printer. The term computer network as discussed in this description is used broadly to define any network such as a local area network (LAN), wide area network (WAN) or private network that a client computer can locally access or remotely attach to and use or download resources from the network. The client is considered to access or be “on” the network regardless of whether the client is physically attached or remotely connected to a local area network. For example, many networks allow a user who is on the Internet to connect through a web browser to a server or computer network. Thus, a user can attach to a network even if they are in a different country or while they are connected via a wireless connection.

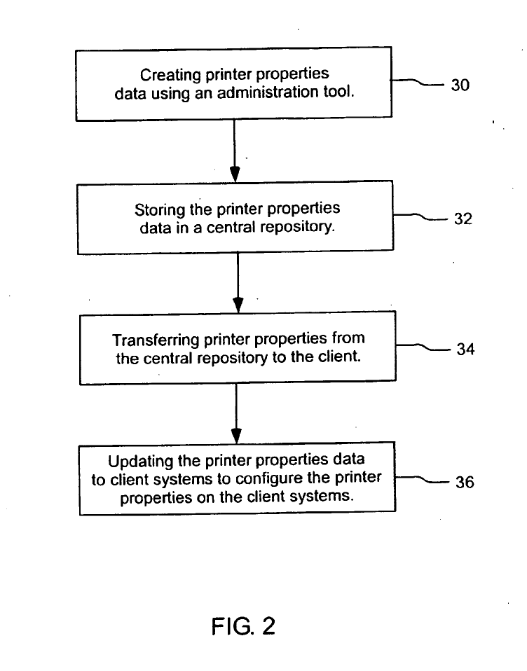

FIG. 2 illustrates a method for configuring the printer properties on networked client computers. The first step is creating printer properties data using an administration tool 30. This is done in the manner described before where a user or administrator is able to create the printer properties using a graphical user interface through the administration tool. In the next step, the printer properties are stored in a central repository 32. The printer properties can be stored in a number of different formats. Using a centralized repository allows the printer properties to be reused for multiple users or groups that are on the network. The stored printer properties are then transferred to client systems 34 to configure the printer properties on the client systems 36.

The functionality included in this method is significant because prior network administration tools have not provided a solution for centrally storing printer properties for all the printers on the network and then selectively distributing them to clients across a network. Storing the properties in a centralized repository allows the properties to be regenerated as regularly as needed. These properties are also stored in a partially installed format for later import into a client machine.

One particular embodiment of the invention can store the printer profile on a separate electronic storage medium or place other than a central repository. The printer profile can be stored in a local storage location such as the client's local hard drive or in some other accessible location. In addition, the printer profile can be located with the printer driver files so that whenever the printer is installed using the associated driver, the printer profile file can be read when the printer is installed. For example, the system can copy the printer profile into the file structure of the printer driver and this can enable the printer installer to access and use the printer profile when the printer driver is installed. In the past, network administrators have not been able to take the printer properties and then have those selected printer properties automatically loaded directly onto client systems to immediately configure the printer properties.

The present invention also overcomes one of the problems with simply replicating the printer properties information between computers. The problem is that the printer properties include certain settings that should be set by the client computer upon install and cannot be set by the user or replicated between machines. Thus, the install tool must be able to differentiate between these different properties. The present invention only transfers and configures the needed printer properties.

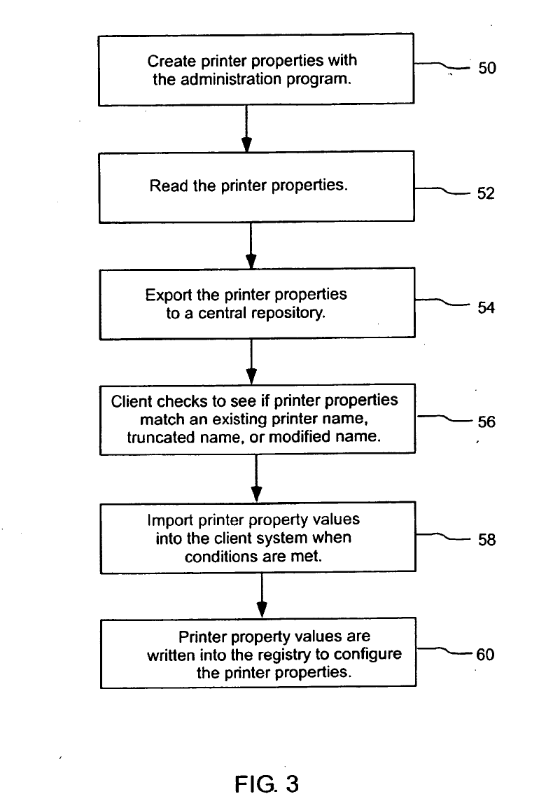

FIG. 3 is a flow chart illustrating a more detailed method for configuring printer properties on one or more client computer systems. Initially, a network administrator or user executes the printer property administration program which enables the creation of printer properties 50. The network administrator may then select a printer that will be provided to them in a printer browser screen. This listing of printers can include all of the printers that are a part of a local network or an organization's larger wide area network. The administrator sets up this list of printers and the list is generally representative of the printers that are available on the network. Of course, the list of printers may also be imported from the network directory system or another listing of the networked printer objects.

As mentioned, the administrator then opens a window for the printer properties by selecting a printer from the printer browser screen. The program will either call the actual graphical user interface (GUI) window used for the printer driver dialogue box, or the administration program will open its own window to enter the printer properties. If the administration program uses its own window, it may simulate the look and feel of the printer properties window for the specific driver. Then the network administrator is able to make any changes that are necessary to the paper source, paper size, trays, duplex option and other modifiable options. The printer properties administrator will then capture the properties for the printer that has been selected.

In the situation where the network administrator has previously set up the printer properties for a specific printer, the administrative tool will first load the printer properties settings from the central repository before the printer properties window is opened. This allows the network administrator to see the printer settings that they have previously configured. An advantage of this approach is that the network administrator will not have to reconfigure a printer from scratch every time they want to set the printer properties.

After the network administrator makes the desired changes to the printer properties, the administrator tool reads the printer properties values 52 and creates the printer profile that is then stored. During the process of reading the printer properties the administrator tool may selectively avoid reading properties that are machine specific that should not exist in the resulting printer profile. Generally, there are machine specific printer properties that are assigned by the client computer as the printers are installed by the prior art network administration software. These values generally should not be propagated from the central repository with the other printer properties and are generally stripped out at some point in the process before they are distributed to the client computers. These printer properties are then exported to a central repository 54 which may be stored on a server, on the network administrator's computer, or in another location. It is also possible that the printer properties stored in the central repository can be distributed to remote servers, which are located at a separate location. This allows a single network administrator to control the printer properties for printers on the network regardless of whether they are located onsite with the administrator or associated with a wide area network. Because the administration program saves the printer properties to a central location, then the printer property clients can quickly and easily retrieve that information from that central location.

At some later point, the client properties program on the client system will execute. The client properties program will either execute when the user logs in, execute as requested, or it can be a background process that runs periodically or at a specified system event. For example, the printer configuration program may run once every hour to ensure that the printer properties do not change.

The client properties program 29 checks to see if the printer name that exists on the client computer matches with an existing printer name that has been configured with the administrator tool 56. The printer name on the client computer may be a truncated printer name, or modified printer name. Matching of printer names is needed in operating systems where the printer name can be renamed, truncated, or otherwise modified by the printer installer program or user. In some operating systems the printer installer is not allowed to modify the printer name and it is more straightforward to match the actual printer names to the associated printer properties profile.

When a matching printer name is found, the client program compares the printer property profile that is currently configured on the client computer with the printer property profile stored in the central repository. The printer property profile on the client computer can be compared with the printer property profile stored in the central repository based upon any number of conditions. Specifically, the client program can check to see if the client computer system has the correct version of the printer properties. Alternatively, the client program can be set up to configure the printer properties once when it loads the first time and then allow the users to do any further configuration they desire. Another comparison condition can be that the printer properties configuration will install new printer properties once for each new version of the printer properties created by the network administrator.

For example, if the client system had printer properties that were version 5.0 and the network administrator had created a new version 6.0, the new version 6.0 printer properties would be configured when the client properties program checks for version updates. The version can also be designated by a timestamp. When the conditions that have been set by the network administrator are found by the client program to have been met, then the printer property profile is imported from the centralized repository 58. Next, the printer property profile is formatted appropriately and written into the operating system registry as configured printer properties 60. In the event that the specific operating system does not use a registry, these values may be written into the database or file where the driver properties are stored.

Another example of a printer property that can be set with the current system is the user's default printer setting. The network administrator user can set up a user to belong to a certain group that uses a specific printer as their default printer. This optional function can be set for all the users who are in the group and when the client properties program executes for that user, then each user's default printer will be set.

The present system and method for configuring printer properties is valuable to system administrators because they are able to avoid visiting each and every computer to configure the properties on those client computers. Although the prior art provides some services for installing applications and printers, the lack of a configuration of the printer properties means that the administrator may save two or three minutes of install time, but they must still incur the travel time and the discussion time associated with configuring the unique printer properties that are associated with each separate client computer. Thus, the present invention saves the network administrator a significant amount of time, energy and travel. Corporations benefit from this invention because they are able to save money based on the number of network administrators hired and apply their network administrator's time to things such as upgrades, security and upkeep of the network. In addition, management now has a way to enforce corporate printing policies. The corporation can adopt a policy that states that duplex printing is mandatory, and have a easy way of enforcing the corporate printing policy.

It is to be understood that the above-described arrangements are only illustrative of the application for the principles of the present invention. Numerous modifications and alternative arrangements can be devised without departing from the spirit and scope of the present invention. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variation in size, materials, shape, form, function and manner of operation, assembly and use may be made without departing from the principles and concepts set forth herein.

What is claimed is:

1. A method for distributing printer properties for a client computer on a computer network, comprising the steps of:
storing printer property data in a central repository on the computer network;
transferring a printer property profile that is selected from the central repository to the client computer; and
updating the printer property profile in the client computer's printer configuration settings so that the client computer possesses current printer properties as defined by the central repository.

2. The method of claim 1, wherein printer properties are configured for one or more client computers on a computer network.

3. The method of claim 1, wherein the step of transferring the printer property profile from the central repository to the client computer further includes the steps of:
checking the central repository to determine if a printer name that exists on the client computer also exists on the central repository; and
transferring the corresponding printer property profile from the central repository to the client computer.

4. The method of claim 1, wherein the step of updating the printer property profile in the client computer's printer configuration settings further includes the step of writing the printer property profile to a storage location selected from the group of storage locations consisting of a database, file, and operating system registry on the client computer.

5. A method for distributing printer properties for a client computer on a computer network, comprising the steps of:
creating printer property data to be stored to a central repository using an administration tool;
storing the printer property data in the central repository;
checking the central repository to determine if a printer name that exists on the client computer also exists on the central repository;
comparing a printer property profile stored in the central repository that corresponds with the printer property profile stored on the client computer to determine if the printer property profile in the client computer needs to be updated with the printer property profile stored in the central repository;
transferring the printer property profile from the central repository to the client computer; and
writing the printer property profile to the client computer's printer configuration settings.

6. The method of claim 5, wherein printer properties are configured for one or more client computers on a computer network.

7. The method of claim 5, wherein the step of creating printer property data using an administration tool further comprises the steps of:
generating a listing of printers located on a computer network;
selecting a printer from the listing of printers;
loading the printer property data previously stored in the central repository into the administration tool to eliminate the need for the user to re-enter data that does not need to be changed;
generating a graphical user interface (GUI) window that contains the loaded printer property data, configured to allow a user to enter new printer property data for the printer; and
setting the printer property data for the printer.

8. The method of claim 7, wherein the step of generating a listing of printers is performed by importing the list from a network directory system.

9. The method of claim 7, wherein the GUI window is a printer properties window that is associated with a printer driver.

10. The method of claim 7, wherein the GUI window is a simulation of the look and feel of a printer properties window that is associated with a printer driver.

11. The method of claim 5, which further includes the step of formatting the printer property profile prior to writing it to the client computer's printer configuration settings.

12. The method of claim 5, wherein the step of writing the printer property profile to the client computer's printer configuration settings further includes the step of writing the printer property profile to a storage location selected from the group of storage locations consisting of a database, file, and operating system registry on the client computer.

13. A system for distributing printer properties for client computers on a computer network comprising:
an administration tool configured to create and manage printer property data;
a central repository configured to store the printer property data created by the administration tool; and
a client properties program on client computers, configured to poll the central repository at predefined intervals, and download a printer property profile from the central repository to client computers to update printer configuration settings.

14. The system of claim 13, wherein printer properties are configured for one or more client computers on a computer network.

15. The system of claim 13, wherein the administration tool is stored and run on an administrator's computer system that is connected to the computer network.

16. The system of claim 13, wherein the central repository is stored on a server.

17. The system of claim 13, wherein the central repository is stored on a network administrator's computer.

18. The system of claim 13, wherein the central repository stores separate files for each of the printer property profiles that exist on the computer network.

19. The system of claim 13, wherein the central repository includes a flat file that stores each of the printer property profiles in separate groups.

20. The system of claim 13, wherein the central repository stores the printer property data in a relational database, and the printer property data are stored in tables.

21. The system of claim 13, wherein the client properties program stores the printer property profile downloaded from the central depository to update the client computer's printer configuration settings.

22. A method for distributing printer properties to at least one client computer on a computer network, comprising the steps of:
configuring a printer property profile using an administrator tool;
storing the printer property profile on an electronic storage medium;
applying the stored printer property profile to a printer on the client computer so that the client computer possesses current printer properties as defined by the printer properties profile.

23. The method of claim 22, wherein the step of storing the printer property profile further comprises the step of storing the printer property profile on a local hard drive on the client computer.

24. The method of claim 22, wherein the step of storing the printer property profile on the computer network further comprises the step of storing the printer property profile on a removable storage medium.

25. The method of claim 22, wherein the step of storing the printer property profile on the computer network further comprises the step of storing the printer property profile on a network storage device.
